(19) United States
(12) Patent Application Publication
(10) Pub. No.: US 2013/0212105 A1
(43) Pub. Date: Aug. 15, 2013

(54) INFORMATION PROCESSING APPARATUS, INFORMATION PROCESSING METHOD, AND PROGRAM

(71) Applicant: Sony Corporation, (US)

(72) Inventors: Takehiro HAGIWARA, Tokyo (JP); Katsuyoshi Kanemoto, Chiba (JP); Hiroyuki Masuda, Kanagawa (JP); Tomohiro Tsunoda, Tokyo (JP)

(73) Assignee: Sony Corporation, Tokyo (JP)

(21) Appl. No.: 13/718,132

(22) Filed: Dec. 18, 2012

(30) Foreign Application Priority Data
Feb. 10, 2012 (JP) 2012-026965

(51) Int. Cl. G06F 17/30

(52) U.S. Cl. CPC G06F 17/30705
USPC 707/737

(57) ABSTRACT

There is provided an information processing apparatus including a cluster information acquiring unit that acquires information of clusters into which users and items are classified, based on item use logs of the users, an item score calculating unit that calculates scores of the items with respect to the users, based on first scores showing attributions of the users with respect to the clusters and second scores being set for the respective clusters and showing attributions of the items with respect to the clusters, which are included in the information of the clusters, and an item selecting unit that selects at least one item from the items according to the scores of the items.

### BACKGROUND

The present disclosure relates to an information processing apparatus, an information processing method, and a program.

As technology selected to recommend items such as a musical composition, a television program, and video content for a user in consideration of a personal preference, collaborative filtering using a co-occurrence relation of a log or content-based filtering (CBF) has been known.

In this case, the collaborative filtering is technology for accumulating item use logs of a large number of users as patterns of preferences and selecting an item used by another user estimated as a user having a similar pattern of a preference based on the logs. Technology using the collaborative filtering is described in Japanese Patent Application Laid-Open No. 2005-332265.

The CBF is technology for accumulating a content use log of a user, estimating a similar relation between pieces of contents using metadata of the pieces of contents, and selecting content similar to content which the user uses in the past. Technology using the CBF is described in Japanese Patent Application Laid-Open No. 2007-058842.

### SUMMARY

Recently, the number of items becoming recommendation objects or the number of users who desire to obtain recommended items has increased. However, in the item selection using the technologies described above, if the number of items or the number of users increases, a calculation cost to match the logs by a server to provide recommendation information for the users increases and it is difficult to smoothly provide the recommendation information.

It is desirable to provide an information processing apparatus, an information processing method, and a program that enable a calculation cost to select an item to be suppressed.

According to an embodiment of the present disclosure, there is provided an information processing apparatus including a cluster information acquiring unit that acquires information of clusters into which users and items are classified, based on item use logs of the users, an item score calculating unit that calculates scores of the items with respect to the users, based on first scores showing attributions of the users with respect to the clusters and second scores being set for the respective clusters and showing attributions of the items with respect to the clusters, which are included in the information of the clusters, and an item selecting unit that selects at least one item from the items according to the scores of the items.

Further, according to an embodiment of the present disclosure, there is provided an information processing method including acquiring information of clusters into which users and items are classified, based on item use logs of the users, calculating scores of the items with respect to the users, based on first scores showing attributions of the users with respect to the clusters, and second scores being set for the respective clusters and showing attributions of the items with respect to the clusters, which are included in the information of the clusters, and selecting at least one item from the items according to the scores of the items.

Further, according to an embodiment of the present disclosure, there is provided a program for causing a computer to realize a function of acquiring information of clusters into which users and items are classified, based on item use logs of the users, a function of calculating scores of the items with respect to the users, based on first scores showing attributions of the users with respect to the clusters and second scores being set for the respective clusters and showing attributions of the items with respect to the clusters, which are included in the information of the clusters, and a function of selecting at least one of the items according to the scores of the items.

According to the above configuration, in the information of the cluster used to calculate the item score to select the item, the score showing the attribution of the item with respect to the cluster is set for each cluster. Therefore, the number of clusters or scores used to calculate the item score can be suppressed to the predetermined number or the information of the cluster can be easily updated when an item is added or a new item is used.

According to the embodiments of the present disclosure described above, a calculation cost to select an item can be suppressed.

### BRIEF DESCRIPTION OF THE DRAWINGS

FIG. 1 is a diagram illustrating an example of an item use log according to a first embodiment of the present disclosure;

FIG. 2 is a diagram illustrating an example of cluster generation according to the first embodiment of the present disclosure;

FIG. 3 is a diagram illustrating an example of score setting according to the first embodiment of the present disclosure;

FIG. 4 is a diagram illustrating another example of score setting;

FIG. 5 is a block diagram illustrating a functional configuration of an apparatus according to the first embodiment of the present disclosure;

FIG. 6 is a diagram illustrating a first example of recommending an item for a user in the first embodiment of the present disclosure;

FIG. 7 is a diagram illustrating a second example of recommending an item for a user in the first embodiment of the present disclosure;

FIG. 8 is a diagram illustrating an example of item updating in the first embodiment of the present disclosure;

FIG. 9 is a diagram illustrating an example of difference learning in the first embodiment of the present disclosure;

FIG. 10 is a block diagram illustrating a functional configuration of an apparatus according to a second embodiment of the present disclosure; and

FIG. 11 is a block diagram illustrating a hardware configuration of an information processing apparatus.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The following description will be made in the order described below.

### 1. First Embodiment

1-1. Outline of Technology

1-2. Configuration of Apparatus

1-3. Example of Processing

### 2. Second Embodiment

2-1. Configuration of Apparatus

### 3. Supplement

### 1. First Embodiment

### (1-1. Outline of Technology)

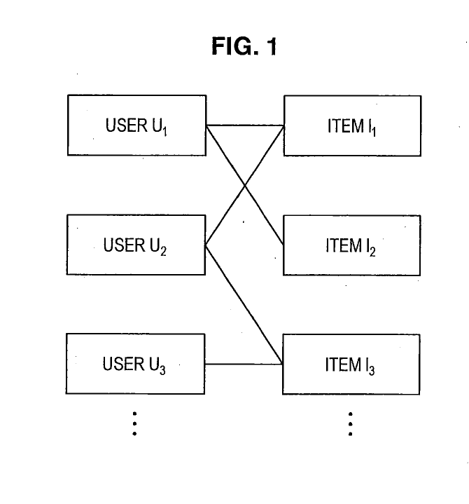

An outline of technology according to a first embodiment of the present disclosure will be described with reference to FIGS. 1 to 4.

### (Acquisition of Item Use Log)

First, acquisition of an item use log that becomes a base of information used to recommend an item for a user will be described with reference to FIG. 1. FIG. 1 is a diagram illustrating an example of an item use log according to the first embodiment of the present disclosure.

Referring to FIG. 1, an example of an item use log when items I₁ to I₃ are used by users U₁ to U₃ is illustrated. In the example illustrated in FIG. 1, the user U₁ uses the items I₁ and I₂, the user U₂ uses the items I₁ and I₃, and the user U₃ uses the item I₃. As such, the item use log may be expressed as a graph showing a relation of the users U and the items I. The number of users U and items I illustrated in FIG. 1 is only exemplary and a large number of users U and items I may exist in actuality.

In the present disclosure, the items are various products such as a musical composition, a television program, video content, and an electronic book which are provided through a network. The items may not be provided through the network. For example, if the item use log illustrated in FIG. 1 can be acquired, the items may be products that are sold in a real shop. The items are not used only when the user pays the price for the items and purchases the items. For example, the use of the items may be watching of a free television program and use of a sample.

When the number of users and the number of items increase, the item use log may become enormous dimensional data. Therefore, in this embodiment, clusters into which users and items are classified are generated and the dimension of data is compressed. All known technologies such as probabilistic latent semantic analysis (PLSA) or latent dirichlet allocation (LDA) described in Japanese Patent Application Laid-Open No. 2011-175362 can be applied to generation of the clusters.

### (Generation of Cluster)

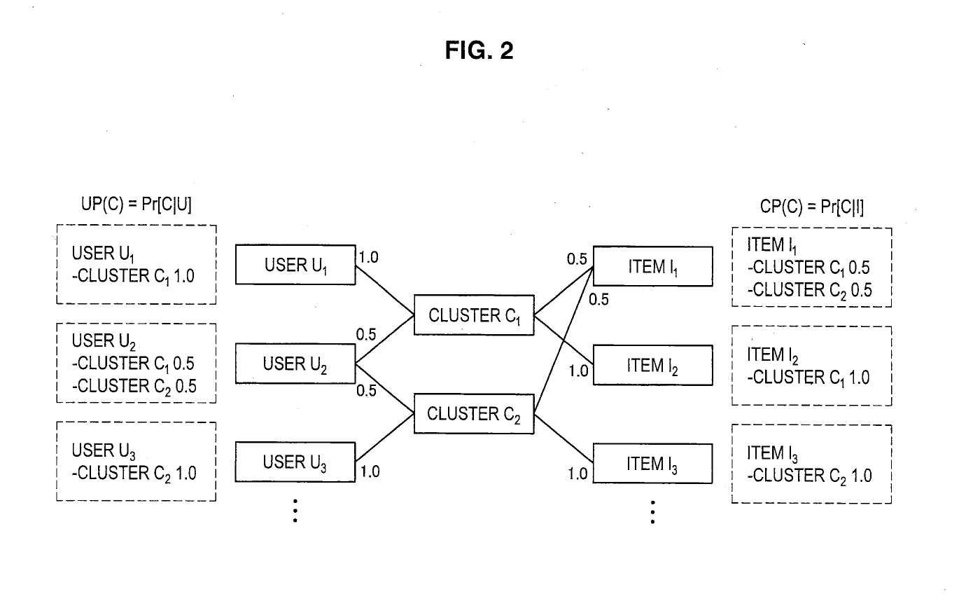

Next, generation of a cluster based on an item use log will be described with reference to FIG. 2. FIG. 2 is a diagram illustrating an example of generation of a cluster according to the first embodiment of the present disclosure.

Referring to FIG. 2, an example of the case in which two clusters C₁ and C₂ are generated from the item use log illustrated in FIG. 1 is illustrated. Numbers that are added to lines between users U and clusters C and lines between items I and the clusters C show attributions of the users U and the items I with respect to the clusters C, respectively.

In this case, an attribution that is set with respect to the cluster will be described. An attribution Pr [C|U] of the user U with respect to the cluster C shows the probability of the user U being attributed to the cluster C. That is, the attribution Pr [C|U] shows the probability of the user U being classified into the cluster C, when the user U uses any item. In the example illustrated in the drawings, the user U₁ uses the items I₁ and I₂. However, in all cases, the user U₁ is classified into the cluster C₁. Therefore, an attribution Pr [C₁|U₁] of the user U₁ with respect to the cluster C₁ is 1.0. The attribution Pr [C|U] is a score UP (C) of the cluster C for each user U.

Meanwhile, an attribution Pr [C|I] of the item I with respect to the cluster C shows the probability of the item I being attributed to the cluster C. That is, the attribution Pr [C|I] shows the probability of the item I being classified into the cluster C, when the item I is used by any user. In the example illustrated in the drawings, the item I₁ is classified into the cluster C₁ when the item I₁ is used by the user U₁ and is classified into the cluster C₂ when the item I₁ is used by the user U₂. Therefore, both the attributions Pr [C₁|I₁] and Pr [C₂|I₁] of the item I₁ with respect to the clusters C₁ and C₂ are 0.5. The attribution Pr [C|I] is a score CP (C) of the cluster C for each item I.

As such, if the clusters C into which the users U and the items I are classified are generated, combinations of the users U and the items I can be expressed by the finite clusters C. Therefore, the dimension of the data is compressed and a calculation cost of matching when the item is recommended for the user can be decreased to some extent.

However, if the score CP (C) set for each item I is used as a score for matching, the number of items I increases. As a result, the number of scores CP (C) referred to at the time of matching increases. For this reason, it is difficult to sufficiently decrease the calculation cost. Therefore, in the first embodiment of the present disclosure, the score CP (C) is set for each cluster C as will be described below.

### (Setting of Score)

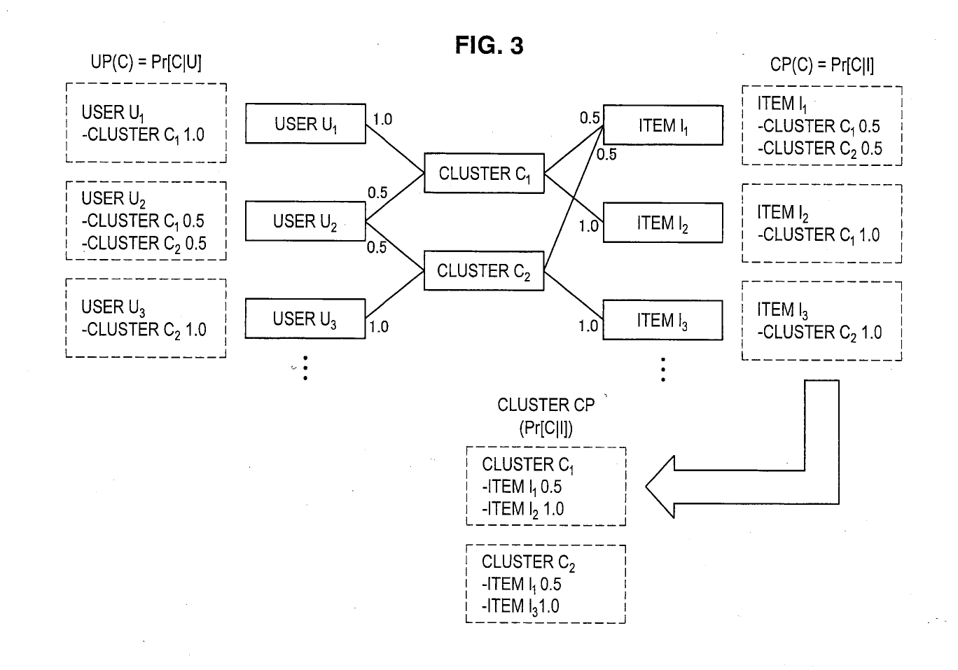

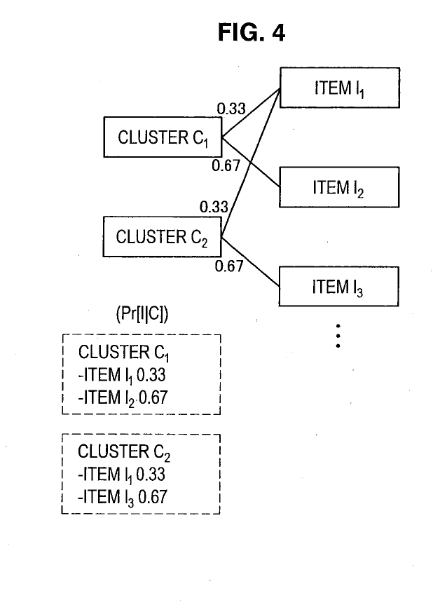

Next, setting of a score regarding a cluster will be described with reference to FIGS. 3 and 4. FIG. 3 is a diagram illustrating an example of score setting according to the first embodiment of the present disclosure. FIG. 4 is a diagram illustrating another example of score setting.

Referring to FIG. 3, an example of the case in which a cluster CP is set as a score for each of two clusters C₁ and C₂ generated similarly to the example of FIG. 2 is illustrated. The cluster CP is obtained by sorting “score CP (C)=attribution Pr [C|I]” set for each item I in the example of FIG. 2, for each cluster C.

In this case, a sum of scores CP (C) with respect to a certain item I is 1 (because the item I is attributed to any cluster C). Meanwhile, because the cluster CP is obtained by sorting the scores CP (C) set for each item I for each cluster C, a sum of clusters CP with respect to a certain cluster C is not necessarily 1.

Meanwhile, FIG. 4 illustrates an example of the case in which an attribution Pr [I|C] of a cluster C with respect to an item I is set to each of two clusters C₁ and C₂ generated similarly to the example of FIG. 2, as another example for comparison with FIG. 3. Numbers that are added to lines between items and clusters correspond to attributions Pr [I|C]. Because the cluster C is attributed to any item I, a sum of attributions Pr [I|C] with respect to a certain cluster C is 1.

In this embodiment, instead of the attribution Pr [I|C] illustrated in FIG. 4, the cluster CP illustrated in FIG. 3 is used as a score set for each cluster. Advantages in that case will be described in detail below.

### (Summarization of Outline)

As described above, in this embodiment, the relations between the users U and the items I are expressed by the clusters C. In this case, if the number of clusters C is limited, the relations between the users and the items can be expressed by the finite clusters even when the number of items increases. In this embodiment, the score UP (C) of the cluster is set for each user. Thereby, when there is an action of the use of the item by the user, the score UP (C) for each user may be only differently updated according to the action and calculations regarding all of the clusters C may not be executed again.

In this embodiment, the score CP (C) for each item I is sorted for each cluster C and is used as the cluster CP. Thereby, the number of clusters CP that are held for each cluster C is limited to the predetermined number in order from the highest score or lower scores than a predetermined threshold value are discarded to limit the number of clusters CP to the predetermined number or less. Therefore, the relations between the users U and the items I can be expressed by the finite clusters C and the amount of data held in the cluster C can be appropriately set in consideration of a processing load, a storage cost, and a communication cost.

### (1-2. Configuration of Apparatus)

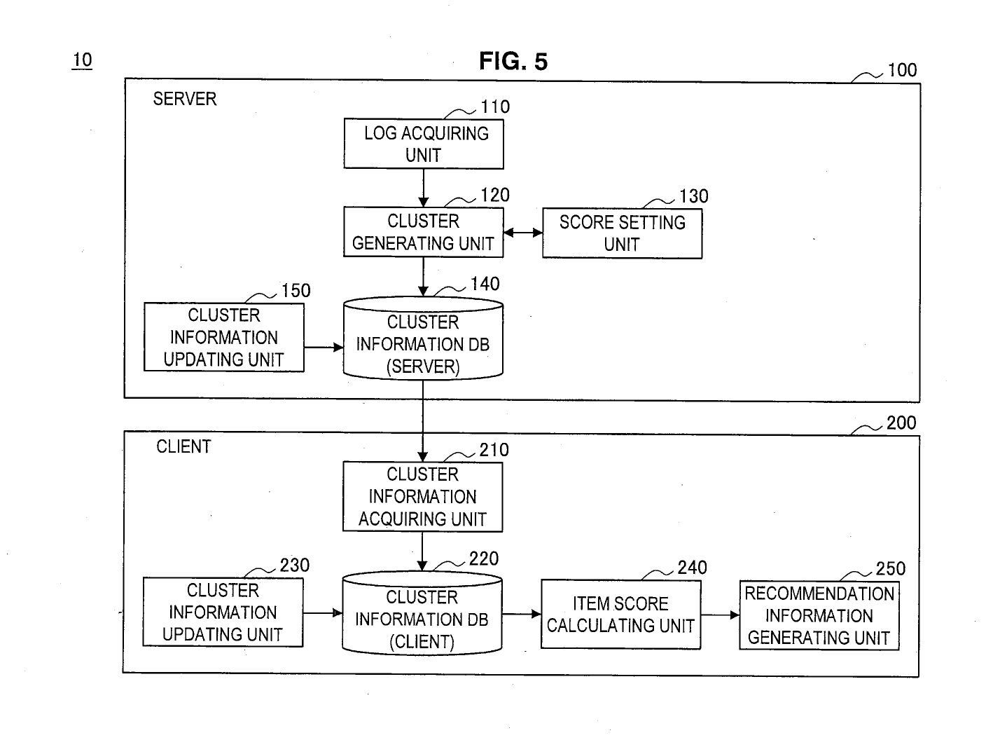

Referring to FIG. 5, a configuration of an apparatus according to the first embodiment of the present disclosure will be described. FIG. 5 is a block diagram illustrating a functional configuration of the apparatus according to the first embodiment of the present disclosure.

A system 10 according to this embodiment includes a server 100 and a client 200. The server 100 includes a log acquiring unit 110, a cluster generating unit 120, a score setting unit 130, a cluster information DB 140, and a cluster information updating unit 150. The client 200 includes a cluster information acquiring unit 210, a cluster information DB 220, a cluster information updating unit 230, an item score calculating unit 240, and a recommendation information generating unit 250.

The server 100 and the client 200 may be realized as an information processing apparatus that has a hardware configuration to be described below. Hereinafter, structural elements of each of the server 100 and the client 200 will be described.

### (Server)

The log acquiring unit 110 is realized by a central processing unit (CPU), a random access memory (RAM), and a read only memory (ROM) and acquires an item use log. The item use log is data that shows a relation of the user and the client illustrated in FIG. 1. The log acquiring unit 110 may communicate with an item provision server on a network and acquire the item use log. For example, when the server 100 is the item provision server, the log acquiring unit 110 may internally acquire the item use log.

The cluster generating unit 120 is realized by a CPU, a RAM, and a ROM and generates cluster information based on the item use log acquired by the log acquiring unit 110. The cluster is a cluster into which the users and the items are classified, as illustrated in FIG. 2. As described above, the cluster generating unit 120 uses a variety of known methods such as a PLSA and an LDA, when the users and the items are classified into the clusters.

The score setting unit 130 is realized by a CPU, a RAM, and a ROM and sets information of scores regarding clusters generated by the cluster generating unit 120. In this case, the set scores are the score UP (C) of the cluster C set for each user U and the cluster CP to be the score of the item I set for each cluster C, which are illustrated in FIG. 3. These scores are set based on the attributions among the users, the clusters, and the items.

The cluster information DB 140 is a database that is realized by a storage device and stores cluster information generated by the cluster generating unit 120. In this case, the cluster information includes the information of the scores that are set by the score setting unit 130. The cluster information that is stored in the cluster information DB 140 is transmitted to the client 200 through communication on the network, according to a request from the client 200. As will be described below, the cluster information that is transmitted to the client 200 may be limited to information regarding a part of the clusters.

The cluster information updating unit 150 is additionally provided. The cluster information updating unit 150 is realized by a CPU, a RAM, and a ROM and updates the cluster information stored in the cluster information DB 140. The cluster information may be updated when the user and the item are added or deleted and when a new item is used by the user. Update processing will be described in detail below.

### (Client)

The cluster information acquiring unit 210 is realized by a CPU, a RAM, and a ROM and acquires the cluster information transmitted from the server 100 through the communication on the network. The cluster information that is acquired by the cluster information acquiring unit 210 includes information of the score UP (C) of the cluster C set for each user U and the cluster CP to be the score of the item I set for each cluster C, which are illustrated in FIG. 3. As described above, the cluster information acquiring unit 210 may request the server 100 to transmit the cluster information. At this time, the cluster information acquiring unit 210 may limit the requested cluster information to information regarding a part of the clusters.

The cluster information DB 220 is a database that is realized by a storage device and stores cluster information acquired by the cluster information acquiring unit 210. The cluster information that is stored in the cluster information DB 220 may be cluster information with respect to all of the clusters that are acquired at a predetermined point of time. In this case, the cluster information may be updated by new cluster information, when the cluster information acquiring unit 210 acquires the new cluster information.

In this case, the cluster information that is stored in the cluster information DB 220 may not be necessarily synchronized with the cluster information that is stored in the cluster information DB 140 of the server 100. That is, the cluster information that is held by the client 200 may be at least temporarily different from the cluster information held by the server 100. In this case, processing for synchronizing the cluster information of the server 100 and the client 200 may be executed with a predetermined period.

The cluster information updating unit 230 is additionally provided. The cluster information updating unit 230 is realized by a CPU, a RAM, and a ROM and updates the cluster information that is stored in the cluster information DB 220. The cluster information may be updated when an item is used by the user. The cluster information updating unit 230 and the cluster information updating unit 150 of the server 100 may execute the same update processing of the cluster information. The update processing may be distributed to the cluster information updating unit 150 and the cluster information updating unit 230 for each kind.

The item score calculating unit 240 is realized by a CPU, a RAM, and a ROM and calculates an item score using the cluster information stored in the cluster information DB 220. Specifically, the item score calculating unit 240 calculates an item score using scores such as the score UP (C) of the cluster C set for each user U and the cluster CP to be the score of the item I set for each cluster C, which are included in the cluster information. The item score is used to determine an item recommended for the user, as will be described below.

The recommendation information generating unit 250 is realized by a CPU, a RAM, and a ROM and generates information to recommend the item for the user, based on the item score calculated by the item score calculating unit 240. The generated information is provided to the user through an output device (not illustrated in the drawings) such as a display of the client 200.

### (1-3. Example of Processing)

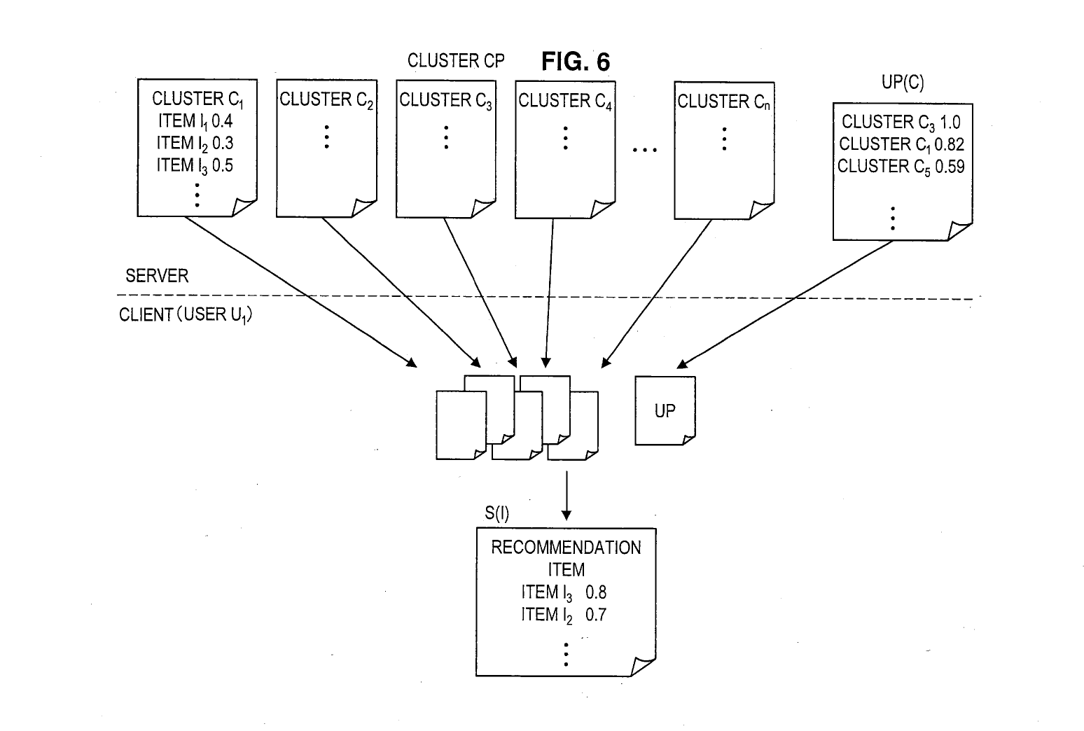

An example of processing according to the first embodiment of the present disclosure will be described with reference to FIGS. 6 to 9.

### (Recommendation of Item for User)

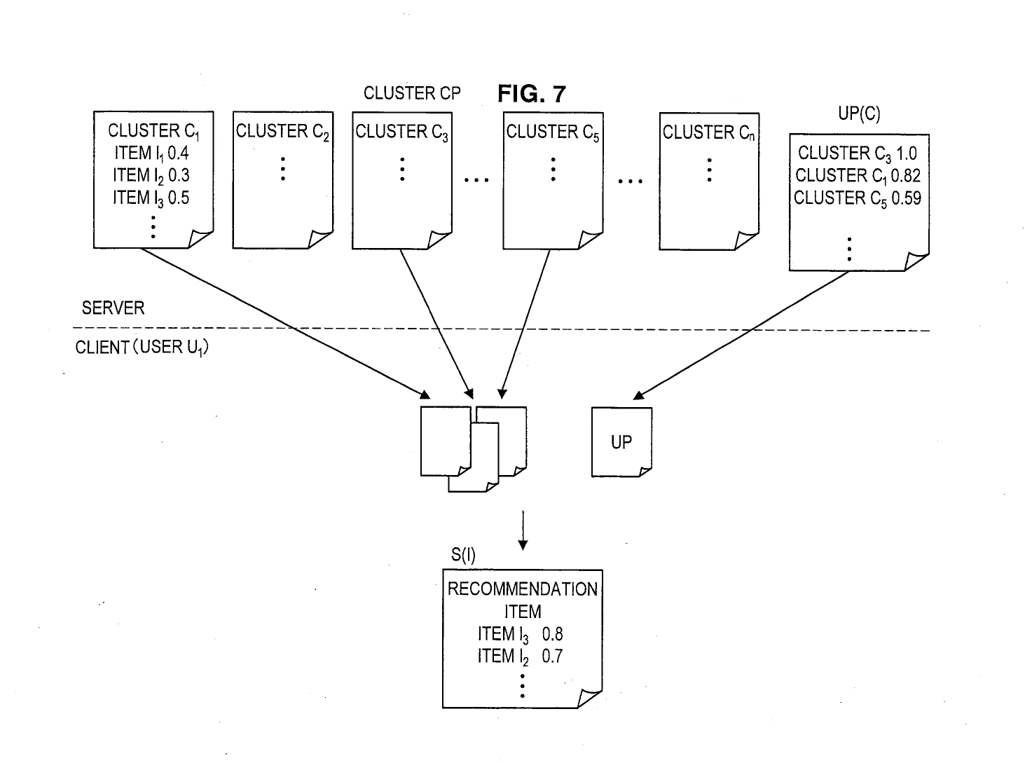

First, processing for recommending an item for the user in the first embodiment of the present disclosure will be described with reference to FIGS. 6 and 7. FIG. 6 is a diagram illustrating a first example of recommending an item for a user in the first embodiment of the present disclosure. FIG. 7 is a diagram illustrating a second example of recommending an item for a user in the first embodiment of the present disclosure.

In this embodiment, the item score calculating unit 240 of the client 200 calculates an item score S (I) using the cluster CP and the score UP (C) with respect to the item recommended user, among the scores regarding the clusters. The recommendation information generating unit 250 generates information to sort the items I in descending order of item scores S (I) and display the items and provides the information as “recommendation items” to the user, so that the items having the higher item scores are recommended for the user.

In the first example illustrated in FIG. 6, the item score calculating unit 240 calculates the item score based on the cluster information of all of the clusters C. For example, the item score calculating unit 240 calculates the item score S (I) by the following expression 1, using the clusters CP (=attributions Pr [C|I]) of all of the clusters C and the score UP (C) of the item recommended user U₁.

S(I)=cos(UP(C),Pr[C|I]) [Expression 1]

In the first example, the item can be accurately recommended by using a mathematically correct method. However, because calculations are executed with respect to all of the clusters, a calculation cost relatively increases. Therefore, a method like the second example to be described below is considered.

In the second example illustrated in FIG. 7, the item score calculating unit 240 calculates an item score based on the predetermined number of cluster information of the clusters C selected in order from the highest score UP (C) of the item recommended user U₁. For example, the item score calculating unit 240 calculates the item score S (I) by the following expression 2, using attributions Pr [I|C]) with respect to the items I of the clusters (three clusters C₃, C₁, and C₅ in the example illustrated in the drawing and the score UP (C) of the item recommended user U₁. The attribution Pr [I|C]) is calculated by normalizing the cluster CP, such that a sum in the cluster C becomes 1. In addition, C_{TOP} shows a group of the predetermined number of clusters C selected in order from the highest score UP (C).

$$S ( I ) = {\sum }_{C ∈ {C}_{TOP}} UP ( C ) * Pr [ I \vert C ] \qquad [ Expression 2 ]$$

In the second example, the item score S (I) is approximately calculated by selectively using cluster information of the clusters C of which the scores UP (C) are higher. Thereby, a calculation cost can be further decreased while an item recommendation having some validity is realized.

In this case, the cluster information that includes the scores such as the cluster CP and the score UP (C) is generated by the server 100, as described above. For example, as illustrated in FIG. 2, when the score CP (C) is set for each item I, generally, the number of items I is large. For this reason, the amount of cluster information that is used when the item score is calculated also increases. Therefore, it is difficult to transmit the cluster information to the client 200 and distribute calculation processing of the item score.

Therefore, in this embodiment, the cluster CP is set as the score for each cluster C. As described above, the number of clusters C can be limited to the predetermined number, regardless of the number of items I. Thereby, the amount of cluster information that is used when the item score is calculated can be suppressed. Therefore, as in the examples described above, the cluster information can be transmitted from the server 100 to the client 200 and the calculation processing of the item score can be distributed.

As described above, the number of clusters CP held for each cluster C can be limited to the predetermined number. As in the second example, the clusters C that are related to the calculation of the item score can be limited to the clusters of which the scores UP (C) are the predetermined ranking or more. Thereby, the amount of cluster information that is transmitted from the server 100 to the client 200 to execute the calculation processing of the item score can be further decreased. In the same manner, the calculation processing of the item score may be distributed to other server, not the client.

### (Item Update)

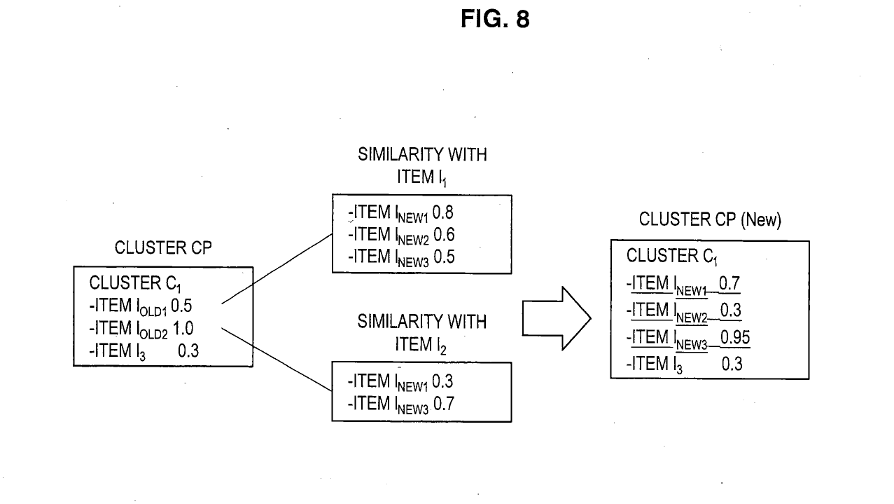

Next, item update processing in the first embodiment of the present disclosure will be described with reference to FIG. 8. FIG. 8 is a diagram illustrating an example of item update in the first embodiment of the present disclosure.

FIG. 8 illustrates an example of the case in which items I_{OLD1} and I_{OLD2} attributed to the cluster C₁ are excluded from recommendable items and items I_{NEW1}, I_{NEW2}, and I_{NEW3} are added to the recommendable items. The items I_{NEW1}, I_{NEW2}, and I_{NEW3} are items that do not exist in a past item use log. However, a similarity of each of the items I_{NEW1}, I_{NEW2}, and I_{NEW3} and the items I_{OLD1} and I_{OLD2} can be known using metadata of content.

In this case, the cluster information updating unit 150 of the server 100 calculates clusters CP of the items I_{NEW1}, I_{NEW2}, and I_{NEW3} in the cluster C₁ by the following expression 3 and replaces the clusters CP of the items I_{OLD1} and I_{OLD2} with the calculated clusters CP. Sim (I_{OLD}, I_{NEW}) is a similarity of the item I_{OLD} and the item I_{NEW}.

$$ClusterCP ( {I}_{NEW} ) = {\sum }_{{I}_{OLD}} ClusterCP ( {I}_{OLD} ) * Sim ( {I}_{OLD , {I}_{NEW}} ) \qquad [ Expression 3 ]$$

If the clusters CP with respect to the items I_{NEW1}, I_{NEW2}, and I_{NEW3} are calculated specifically using the expression 3, the clusters CP are as follows.

Cluster CP(I_{NEW1})=0.5*0.8+1.0*0.3=0.7

Cluster CP(I_{NEW2})=0.5*0.6=0.3

Cluster CP(I_{NEW3})=0.5*0.5+1.0*0.7=0.95

In the cluster C₁ after the update, new clusters CP with respect to the items I_{NEW1}, I_{NEW2}, and I_{NEW3} are held and the clusters CP of the items I_{OLD1} and T_{OLD2} are deleted. Meanwhile, the cluster CP of the item I₃ that is not excluded from the recommendable items is continuously held.

As described above, different from the attribution Pr [I|C], a sum of the clusters CP in the cluster C does not necessarily become 1. Therefore, as described above, when the items are replaced with the different items, scores of new items that are set based on similarities with original items can be used as the clusters CP.

The update processing described above may be realized by the cluster information updating unit 230 of the client 200.

### (Difference Learning)

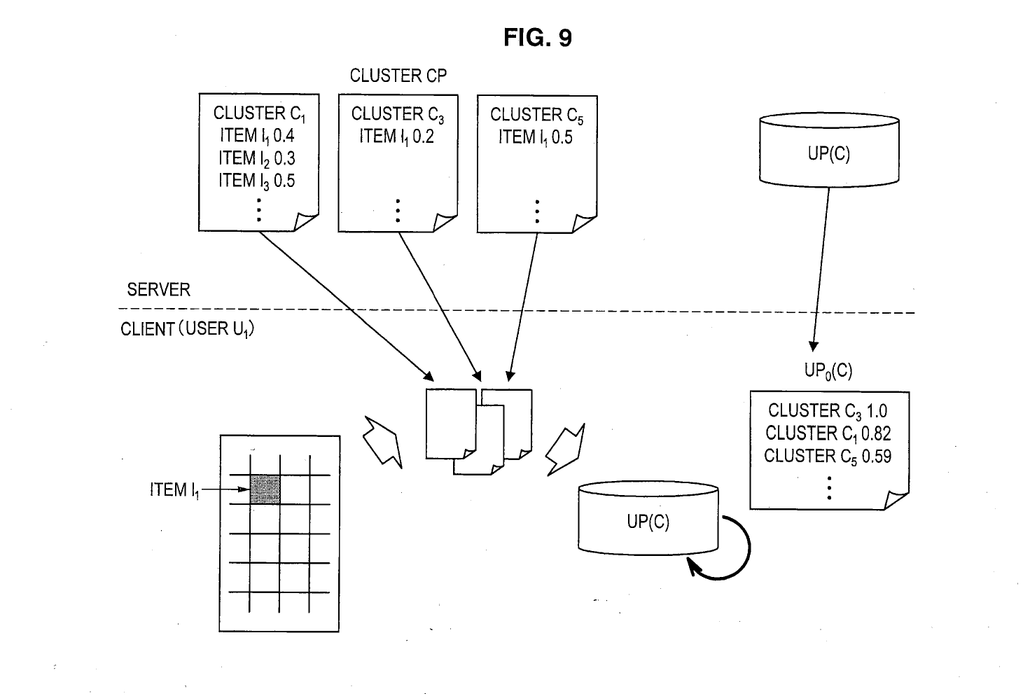

Next, processing of difference learning in the first embodiment of the present disclosure will be described with reference to FIG. 9. FIG. 9 is a diagram illustrating an example of difference learning in the first embodiment of the present disclosure.

FIG. 9 illustrates an example of the case in which an item I₁ is newly used by the client 200 of the user U₁. In this case, the cluster information updating unit 230 of the client 200 updates a score UP (C) of the user U₁ by the following expression 4 or 5. In the expressions 4 and 5, η shows a predetermined coefficient and UP₀ (C) shows a score UP (C) before update.

$$\begin{matrix}UP ( C ) = {UP}_{0} ( C ) + {\sum }_{C} ( η * Pr [ C \vert {I}_{1} ] ) & [ Expression 4 ] \\ UP ( C ) = {UP}_{0} ( C ) + {\sum }_{C} ( η * Pr [ {I}_{1} \vert C ] ) & [ Expression 5 ]\end{matrix}$$

In both the cases, the cluster information updating unit 230 adds a value according to a score (Pr [C|I₁] or Pr [I₁|C]) showing an attribution between the cluster C and the item I₁ to the score UP (C) and updates the score UP (C).

In order to execute the update processing, the cluster information acquiring unit 210 acquires information of the cluster C into which the item I₁ is classified, from the server 100. In other words, the cluster information acquiring unit 210 may not necessarily acquire information of the cluster C into which the item I₁ is not classified (because of Pr [C|I₁]=Pr [I₁|C]=0 in the cluster C). Therefore, the amount of cluster information that is acquired from the server 100 to execute the difference learning in the client 200 can be suppressed.

In the update processing described above, because recalculation with respect to the entire clusters C may not be executed, a calculation cost can be decreased. Therefore, even when the update processing is completed in the client 200, that is, the cluster information updating unit 230 updates the cluster information stored in the cluster information DB 220, this embodiment is effective.

When the expression 5 is used, the cluster information updating unit 230 may update the score UP (C) based on the predetermined number of pieces of the cluster information of the clusters C selected in order from the highest score UP₀ (C) of the user U₁ before the update. In this case, the cluster information updating unit 230 updates the score UP (C) of the user U₁ by the following expression 6. In the expression 6, C_{TOP} shows a group of the predetermined number of the clusters C selected in order from highest score UP₀ (C).

$$UP ( C ) = {UP}_{0} ( C ) + {\sum }_{C ∈ {C}_{TOP}} ( η * Pr [ {I}_{1} \vert C ] ) \qquad [ Expression 6 ]$$

Thereby, the amount of cluster information acquired to execute the difference learning and the calculation cost can be further decreased while the use of the item by the user is reflected to the cluster information with some precision.

When the score UP (C) of the user U₁ is updated by the above processing, UP (C) is different at least temporarily between the server 100 and the client 200. A sum of scores UP (C) with respect to the user U₁ after the update does not necessarily become 1. Therefore, processing for synchronizing the cluster information of the server 100 and the client 200 with a predetermined period or processing for performing normalization such that a sum of scores UP (C) becomes 1 may be executed.

### 2. Second Embodiment

Next, a second embodiment of the present disclosure will be described. The second embodiment of the present disclosure is obtained by realizing the first embodiment with a different apparatus configuration. The second embodiment is the same as the first embodiment, except for the apparatus configuration. Therefore, the apparatus configuration according to the second embodiment will be described below and detailed explanation of the second embodiment other than the apparatus configuration will be omitted.

### (2-1. Configuration of Apparatus)

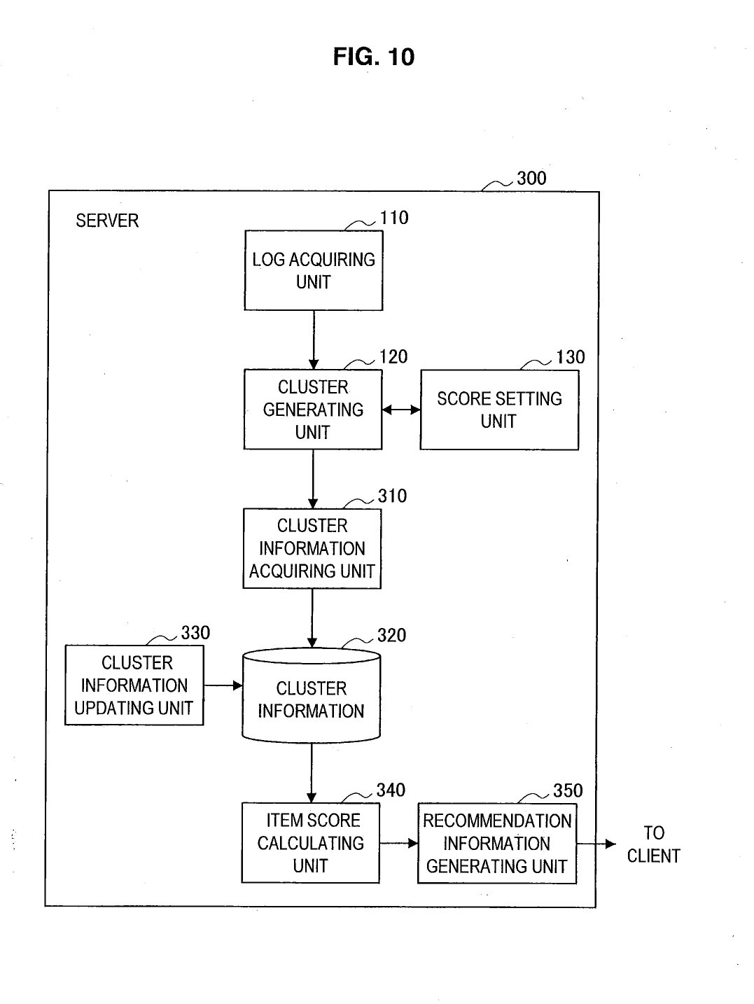

The apparatus configuration according to the second embodiment of the present disclosure will be described with reference to FIG. 10. FIG. 10 is a block diagram illustrating a functional configuration of an apparatus according to the second embodiment of the present disclosure.

In this embodiment, processing from acquisition of an item use log to generation of recommendation information is executed by a server 300. The server 300 includes a log acquiring unit 110, a cluster generating unit 120, a score setting unit 130, a cluster information acquiring unit 310, a cluster information DB 320, a cluster information updating unit 330, an item score calculating unit 340, and a recommendation information generating unit 350.

The server 300 may be realized as an information processing apparatus that has a hardware configuration to be described below. Hereinafter, structural elements of the server 300 will be described.

The log acquiring unit 110, the cluster generating unit 120, the score setting unit 130, the cluster information DB 140, and the cluster information updating unit 150 are the same structural elements as those of the server 100 according to the first embodiment. However, cluster information that is generated by the cluster generating unit 120 is internally transmitted to the cluster information acquiring unit 310, different from the first embodiment.

The cluster information acquiring unit 310, the cluster information DB 320, the cluster information updating unit 330, the item score calculating unit 340, and the recommendation information generating unit 350 are the same structural elements as the cluster information acquiring unit 210, the cluster information DB 220, the cluster information updating unit 230, the item score calculating unit 240, and the recommendation information generating unit 250, which are included in the client 200 according to the first embodiment. However, the second embodiment is different from the first embodiment in that the cluster information acquiring unit 310, the cluster information DB 320, the cluster information updating unit 330, the item score calculating unit 340, and the recommendation information generating unit 350 are included in the server 300, not the client. The cluster information acquiring unit 310 internally acquires the cluster information generated by the cluster generating unit 120 and stores the cluster information in the cluster information DB 320. Information that is generated by the recommendation information generating unit 350 is transmitted to the client through communication on a network, according to a request from the client (not illustrated in the drawings).

In addition, the embodiment of the present disclosure includes various embodiments in which a distribution of functions between the client and the server is changed in a system including the client and the server. That is, the processing that is executed by the server in the embodiment described above may be executed by the client in another embodiment. The processing that is executed by the client in the embodiment described above may be executed by the server in another embodiment.

### 3. Supplement

### (Hardware Configuration)

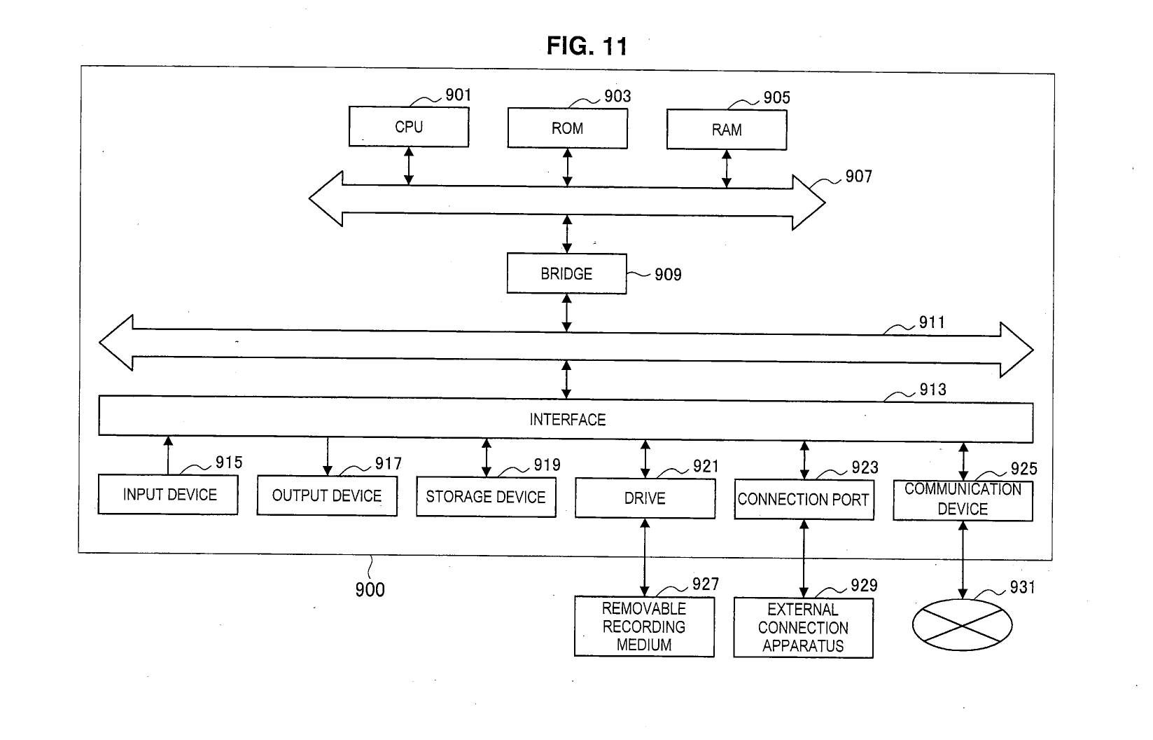

Next, a hardware configuration of an information processing apparatus 900 according to an embodiment of the present disclosure will be described with reference to FIG. 11. FIG. 11 is a block diagram illustrating the hardware configuration of the information processing apparatus.

The information processing apparatus 900 includes a CPU 901, a ROM 903, and a RAM 905. The information processing apparatus 900 may further include a host bus 907, a bridge 909, an external bus 911, an interface 913, an input device 915, an output device 917, a storage device 919, a drive 921, a connection port 923, and a communication device 925.

The CPU 901 functions as an arithmetic processing device and a control device and controls all or a part of operations in the information processing apparatus 900, according to various programs recorded in the ROM 903, the RAM 905, the storage device 919, and a removable recording medium 927. The ROM 903 stores a program or an arithmetic parameter used by the CPU 901. The RAM 905 primarily stores a program used in execution of the CPU 901 or a parameter appropriately changed in the execution thereof. The CPU 901, the ROM 903, and the RAM 905 are mutually connected by the host bus 907 configured using an internal bus such as a CPU bus. The host bus 907 is connected to the external bus 911 such as a peripheral component interconnect/interface (PCI) bus, through the bridge 909.

The input device 915 is a device such as a mouse, a keyboard, a touch panel, a button, a switch, or a lever that is operated by a user. The input device 915 may be a remote control device using infrared rays and other electric waves and may be an external connection apparatus 929 such as a mobile phone corresponding to the operation of the information processing apparatus 900. The input device 915 includes an input control circuit that generates an input signal based on information input by the user and outputs the input signal to the CPU 901. The user operates the input device 915 and inputs various data to the information processing apparatus 900 or instructs the information processing apparatus 900 to execute a processing operation.

The output device 917 is configured using a device that can notify the user of the acquired information visually or aurally. The output device 917 may be a display device such as a liquid crystal display (LCD), a plasma display panel (PDP), and an organic electro-luminescence (EL) display, a sound output device such as a speaker and a headphone, or a printer device. The output device 917 outputs the result obtained by processing of the information processing apparatus 900 in a form of video such as a text or an image or audio such as a sound.

The storage device 919 is a device for data storage that is configured as an example of a storage unit of the information processing apparatus 900. The storage device 919 is configured using a magnetic storage device such as a hard disk drive (HDD), a semiconductor storage device, an optical storage device, or a magneto optical storage device. The storage device 919 stores programs and various data executed and processed by the CPU 901 and various data acquired from the outside.

The drive 921 is a reader/writer for the removable recording medium 927 such as a magnetic disk, an optical disk, a magneto optical disk, or a semiconductor memory and is embedded in or mounted externally to the information processing apparatus 900. The drive 921 reads information recorded in the mounted removable recording medium 927 and outputs the information to the RAM 905. The drive 921 writes the information to the mounted removable recording medium 927.

The connection port 923 is a port that is used to directly connect an apparatus to the information processing apparatus 900. For example, the connection port 923 may be a universal serial bus (USB) port, an IEEE1394 port, or a small computer system interface (SCSI) port. Alternatively, the connection port 923 may be an RS-232C port, an optical audio terminal, or a high-definition multimedia interface (HDMI) port. By connecting the external connection apparatus 929 to the connection port 923, various data may be exchanged between the information processing apparatus 900 and the external connection apparatus 929.

The communication device 925 is a communication interface that is configured using a communication device for connection with a communication network 931. For example, the communication device 925 may be a wired or wireless local area network (LAN), a Bluetooth (registered trademark), or a communication card for a wireless USB (WUSB). Alternatively, the communication device 925 may be a router for optical communication, a router for an asymmetric digital subscriber line (ADSL), or a modem for various communications. The communication device 925 exchanges a signal using a predetermined protocol such as TCP/IP, with the Internet or another communication apparatus. The communication network 931 that is connected to the communication device 925 is a network that is connected by wire or wireless. For example, the communication network 931 is the Internet, a domestic LAN, infrared communication, radio wave communication, or satellite communication.

The example of the hardware configuration of the information processing apparatus 900 has been described. The structural elements may be configured using versatile members or hardware specialized for the functions of the structural elements. Therefore, the used configuration may be appropriately changed according to a technical level when the embodiment is carried out.

### [Summarization]

The effects of the embodiments of the present disclosures described above are summarized. The effects may be obtained in at least a part of the embodiments of the present disclosure. Therefore, in the embodiments of the present disclosure, all of the effects to be described below are not necessarily obtained.

In the embodiments of the present disclosure, the clusters into which the users and the items are classified are generated. Thereby, even when the number of items increases, the scores such as CP and UP can be expressed by the clusters of the predetermined number.

In the embodiments of the present disclosure, the number of scores set for each cluster, for example, the number of clusters CP can be suppressed to the predetermined number.

In the embodiments of the present disclosure, information regarding the clusters of the predetermined number that are common to all of the users may be generated as the cluster information. For this reason, a communication cost between the server and the client or a communication cost between a plurality of servers when there are the plurality of servers and a storage cost when the cluster information is held in the server or the client can be decreased.

In the embodiments of the present disclosure, when the item recommendation information with respect to the user is generated, the item score is approximately calculated by selectively using the information of the clusters having the higher scores UP (C), so that the calculation cost can be decreased.

In the embodiments of the present disclosure, when a new item is used by the user, the scores UP (C) are differently updated, so that recalculation can be prevented from being executed with respect to the entire cluster information, for each action of the user.

In the embodiments of the present disclosure, even when an item is a new item not existing in the item use log of the user, a score can be calculated using a similarity with the items in the cluster and the item can be added to the cluster.

It should be understood by those skilled in the art that various modifications, combinations, sub-combinations and alterations may occur depending on design requirements and other factors insofar as they are in the scope of the appended claims or the equivalents thereof.

Additionally, the present technology may also be configured as below.

(1) An information processing apparatus including:

a cluster information acquiring unit that acquires information of clusters into which users and items are classified, based on item use logs of the users;

an item score calculating unit that calculates scores of the items with respect to the users, based on first scores showing attributions of the users with respect to the clusters and second scores being set for the respective clusters and showing attributions of the items with respect to the clusters, which are included in the information of the clusters; and

an item selecting unit that selects at least one item from the items according to the scores of the items.

(2) The information processing apparatus according to (1),

wherein the information of the clusters includes a predetermined number of the second scores selected in order from a highest second score.

(3) The information processing apparatus according to (1),

wherein the information of the clusters includes the second scores that are equal to or more than a predetermined threshold value.

(4) The information processing apparatus according to any one of (1) to (3), further including:

a cluster information updating unit that, when first items are newly classified into the clusters, sets the second scores of the first items, based on similarities between the first items and other items classified into the clusters and the second scores of the other items.

(5) The information processing apparatus according to any one of (1) to (4),

wherein the item score calculating unit calculates scores of the items using a predetermined number of pieces of the information of the clusters selected in order from information of a cluster having a highest first score.

(6) The information processing apparatus according to any one of (1) to (5), further including:

a cluster information updating unit that, when the users newly use second items classified into the clusters, adds values according to the second scores of the second items to the first scores.

(7) The information processing apparatus according to (6),

wherein the cluster information updating unit adds the values according to the second scores of the second items to the first scores, using a predetermined number of pieces of the information of the clusters selected in order from information of a cluster having a highest second score.

(8) An information processing method including:

acquiring information of clusters into which users and items are classified, based on item use logs of the users;

calculating scores of the items with respect to the users, based on first scores showing attributions of the users with respect to the clusters, and second scores being set for the respective clusters and showing attributions of the items with respect to the clusters, which are included in the information of the clusters; and

selecting at least one item from the items according to the scores of the items.

(9) A program for causing a computer to realize:

a function of acquiring information of clusters into which users and items are classified, based on item use logs of the users;

a function of calculating scores of the items with respect to the users, based on first scores showing attributions of the users with respect to the clusters and second scores being set for the respective clusters and showing attributions of the items with respect to the clusters, which are included in the information of the clusters; and

a function of selecting at least one of the items according to the scores of the items.

The present disclosure contains subject matter related to that disclosed in Japanese Priority Patent Application JP 2012-026965 filed in the Japan Patent Office on Feb. 10, 2012, the entire content of which is hereby incorporated by reference.

What is claimed is:

1. An information processing apparatus comprising:
a cluster information acquiring unit that acquires information of clusters into which users and items are classified, based on item use logs of the users;
an item score calculating unit that calculates scores of the items with respect to the users, based on first scores showing attributions of the users with respect to the clusters and second scores being set for the respective clusters and showing attributions of the items with respect to the clusters, which are included in the information of the clusters; and
an item selecting unit that selects at least one item from the items according to the scores of the items.

2. The information processing apparatus according to claim 1,
wherein the information of the clusters includes a predetermined number of the second scores selected in order from a highest second score.

3. The information processing apparatus according to claim 1,
wherein the information of the clusters includes the second scores that are equal to or more than a predetermined threshold value.

4. The information processing apparatus according to claim 1, further comprising:
a cluster information updating unit that, when first items are newly classified into the clusters, sets the second scores of the first items, based on similarities between the first items and other items classified into the clusters and the second scores of the other items.

5. The information processing apparatus according to claim 1,
wherein the item score calculating unit calculates scores of the items using a predetermined number of pieces of the information of the clusters selected in order from information of a cluster having a highest first score.

6. The information processing apparatus according to claim 1, further comprising:
a cluster information updating unit that, when the users newly use second items classified into the clusters, adds values according to the second scores of the second items to the first scores.

7. The information processing apparatus according to claim 6,
wherein the cluster information updating unit adds the values according to the second scores of the second items to the first scores, using a predetermined number of pieces of the information of the clusters selected in order from information of a cluster having a highest second score.

8. An information processing method comprising:
acquiring information of clusters into which users and items are classified, based on item use logs of the users;
calculating scores of the items with respect to the users, based on first scores showing attributions of the users with respect to the clusters, and second scores being set for the respective clusters and showing attributions of the items with respect to the clusters, which are included in the information of the clusters; and
selecting at least one item from the items according to the scores of the items.

9. A program for causing a computer to realize:
a function of acquiring information of clusters into which users and items are classified, based on item use logs of the users;
a function of calculating scores of the items with respect to the users, based on first scores showing attributions of the users with respect to the clusters and second scores being set for the respective clusters and showing attributions of the items with respect to the clusters, which are included in the information of the clusters; and
a function of selecting at least one of the items according to the scores of the items.
